(19) United States
(12) Patent Application Publication
(10) Pub. No.: US 2022/0276350 A1
(43) Pub. Date: Sep. 1, 2022

(54) LIDAR DEVICE AND OPERATION METHOD THEREOF

(71) Applicant: CARNAVICOM CO., LTD., Incheon (KR)

(72) Inventors: Sung Joo CHO, Seou (KR); Jong Taek JUNG, Incheon (KR)

(21) Appl. No.: 17/681,619

(22) Filed: Feb. 25, 2022

Related U.S. Application Data
(63) Continuation of application No. PCT/KR2020/007778, filed on Jun. 16, 2020.

(30) Foreign Application Priority Data
Aug. 28, 2019 (KR) 10-2019-0105533

(51) Int. Cl. G01S 7/481; G01S 17/02; G02B 26/10

(52) U.S. Cl. CPC G01S 7/4817; G01S 17/02; G02B 26/105

(57) ABSTRACT

A lidar device comprises a light emitting unit configured to radiate at least one light; a reflection mirror configured to reflect the light and have an asymmetrical polygonal shape in which angles of two or more reflection surfaces differ; a rotation unit configured to rotate the reflection mirror; and a controller configured to control the rotation unit. The controller controls the rotation speed to scan an interested area of a scanned area with a resolution higher than other area.

### CROSS-REFERENCE TO RELATED APPLICATIONS

This application is a continuation of pending PCT International Application No. PCT/KR2020/007778, which was filed on Jun. 16, 2020, and which claims priority under 35 U.S.C 119(a) to Korean Patent Application No. 10-2019-0105533 filed with the Korean Intellectual Property Office on Aug. 28, 2019. The disclosures of the above patent applications are incorporated herein by reference in their entirety.

### TECHNICAL FIELD

The present disclosure relates to a lidar device and an operation method thereof.

### BACKGROUND ART

Recently, active control of a vehicle about unexpected situation has been required in a field of an intelligent vehicle and a smart car. That is, it is necessary to verify in advance a situation threatening safety of a driver and a pedestrian, e.g. detect sudden appearance of the pedestrian, detect in advance an obstacle in dark night, detect an obstacle due to a dim light when it is raining or sensing in advance road breakdown, and so on.

A scanner is established on a windshield or a front part of a vehicle, detects a front object by outputting a light when the vehicle moves, alerts to driver based on the detection result, and delivers an image used for stop or evasion of the vehicle to an electronic control unit ECU. The ECU performs various control operations using the delivered image, and the scanner obtains the image.

Conventional scanner is a radio detection and ranging RADAR and a camera using image information. The RADAR outputs an electromagnetic wave such as microwave (wavelength of 10 cm to 100 cm) to the object and receives the electromagnetic wave reflected by the object, and detects a distance to the object, a direction or altitude, etc. through the received electromagnetic wave. The scanner is used for the vehicle, but the azimuth resolution is not good due to diffraction or beamforming and so on. Accordingly, it is not easy to apply the scanner to the vehicle. Recognition ratio of the camera used as the scanner is relatively reduced when it is at night or it is raining.

### SUMMARY

The present disclosure is to provide a lidar device for scanning selectively a desired area with high resolution and operation method thereof.

Additionally, the present disclosure is to provide a lidar device for scanning multiple areas with different resolutions and operation method thereof.

Furthermore, the present disclosure is to provide a lidar device for selecting an interested area by scanning and scanning the interested area with high resolution and operation method thereof.

Moreover, the present disclosure is to provide a lidar device for scanning selectively the interested area with high resolution by using road event information including accident information received from other vehicles.

In one aspect of the disclosure, a lidar device is provided.

A lidar device according to one embodiment of the disclosure includes a light emitting unit configured to radiate at least one light; a reflection mirror configured to have an asymmetrical polygonal shape of which angles of two or more reflection surfaces differ and reflect the light; a rotation unit configured to rotate the reflection mirror; and a controller configured to control the rotation unit. Here, the asymmetrical polygonal shape of the reflection mirror has a structure able to scan an interested area of a scanned area with a resolution higher than other area.

The controller controls the rotation unit to change a rotation speed of the reflection mirror considering the angle of the reflection surface.

Reflection surfaces having a length less than a reference length are sequentially disposed with different angles in the reflection mirror.

The controller controls a rotation speed of the reflection mirror to scan a selected interested area with high resolution when the interested area is selected by accident information or a user's selection.

The light emitting unit includes one or more lasers such as a laser diode LD, and wherein an operation frequency of the laser is adjusted to scan multiple scanned areas with different resolutions.

The light emitting unit includes multiple lasers and adjusts operation frequencies of the lasers to make directions of lights outputted from the lasers different.

The controller controls a rotation speed of the reflection mirror or adjusts an operation frequency of the light emitting unit by controlling the rotation unit to scan a central part of a scanned area and a surrounding part adjacent to the central part with different resolutions.

The controller controls the rotation speed of the reflection mirror and an operation frequency of a laser in the light emitting unit to increase gradually a resolution of the interested area according as a vehicle mounted with the lidar device drives to approach the interested area.

A lidar device according to another embodiment of the disclosure includes a light emitting unit configured to output at least one light, the light emitting unit including a laser; a reflection mirror configured to reflect the light; a rotation unit configured to rotate the reflection mirror; and a controller configured to control the rotation unit. Here, the controller adjusts an operation frequency of the laser to scan an interested area of a scanned area with a resolution higher than other area.

The light emitting unit includes multiple lasers, and wherein the controller adjusts the operation frequency for one of the lasers to scan the interested area with high resolution, and adjusts the operation frequency for another of the lasers to scan the other area with a resolution lower than the resolution of the interested area.

The controller adjusts a rotation speed of the reflection mirror to scan the interested area of the scanned area with a resolution higher than a resolution of the other area.

The operation frequency of the laser is adjusted to scan a selected interested area with high resolution when the interested area is selected by road event information including accident information or a user's selection.

In another aspect of the disclosure, a method of operating a lidar device for scan a desired area with high resolution is provided.

A method of operating a lidar device in a vehicle according to one embodiment of the disclosure includes (a) scanning a scanned area; (b) selecting an interested area by using a scan result of the scanned area; and (c) rotating a reflection mirror with an asymmetrical polygonal shape to scan the interested area with a resolution higher than a resolution of other area.

In the step of ©, the rotation speed of the reflection mirror and Pulse Repetition Frequency (PRF) of a laser is adjusted to increase gradually a resolution concerning on the interested area according as the vehicle mounted with the lidar device drives to approach the interested area.

A method of operating a lidar device in a vehicle according to another embodiment of the disclosure includes (a) selecting an interested area by using accident information when the accident information is received from other vehicle; and (b) adjusting an operation frequency of a laser and a rotation speed of a reflection mirror to scan a fixed scanned area and the interested area with different resolutions.

The fixed scanned area includes multiple adjacent areas, and wherein the step of (b) includes: scanning a first area of the areas with a first resolution by operating one of the lasers with a first operation frequency; and scanning a second area with a second resolution by operating another laser with a second operation frequency.

In the step of (b), the operation frequency of the laser is differently adjusted depending on a distance to the interested area, and wherein the operation frequency is adjusted to increase gradually a resolution concerning on the interested area according as the lidar device approaches the interested area.

A lidar device and operation method thereof according to one embodiment of the disclosure may scan selectively a desired area with high resolution.

Additionally, the lidar device may scan multiple areas with different resolutions.

Furthermore, the lidar device may select an interested area by its scanning and scan the interested area with high resolution.

Moreover, the lidar device may extend a horizontal scanned area or a vertical scanned area.

Additionally, the lidar device may scan selectively the interested area with high resolution by using road event information including accident information received from other vehicle.

### BRIEF DESCRIPTION OF DRAWINGS

Example embodiments of the present disclosure will become more apparent by describing in detail example embodiments of the present disclosure with reference to the accompanying drawings, in which:

FIG. 1 is a block diagram illustrating schematically a lidar device according to an embodiment of the disclosure;

FIG. 2 is a view illustrating schematically light transmitting modules according to an embodiment of the disclosure;

FIG. 3 is a view illustrating method of increasing a vertical resolution according to an embodiment of the disclosure;

FIG. 4 is a view illustrating schematically a light receiving module according to an embodiment of the disclosure;

FIG. 5 is a view illustrating a shape of a reflection mirror according to an embodiment of the disclosure;

FIG. 6 is a view illustrating method of dividing a scanned area to multiple areas with different resolution and scanning the areas according to an embodiment of the disclosure;

FIG. 7 is a flow chart illustrating an operation method of the lidar device according to an embodiment of the disclosure;

FIG. 8 is a flow chart illustrating an operation method of the lidar device according to another embodiment of the disclosure;

FIG. 9 and FIG. 10 are views illustrating reflection of a light by rotation of a reflection mirror according to an embodiment of the disclosure; and

FIG. 11 is a view illustrating a method of scanning a part of a scanned area with high resolution according to an embodiment of the disclosure.

### DETAILED DESCRIPTION

In the present specification, an expression used in the singular encompasses the expression of the multiple, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

Hereinafter, embodiments of the disclosure will be described in detail with reference to accompanying drawings.

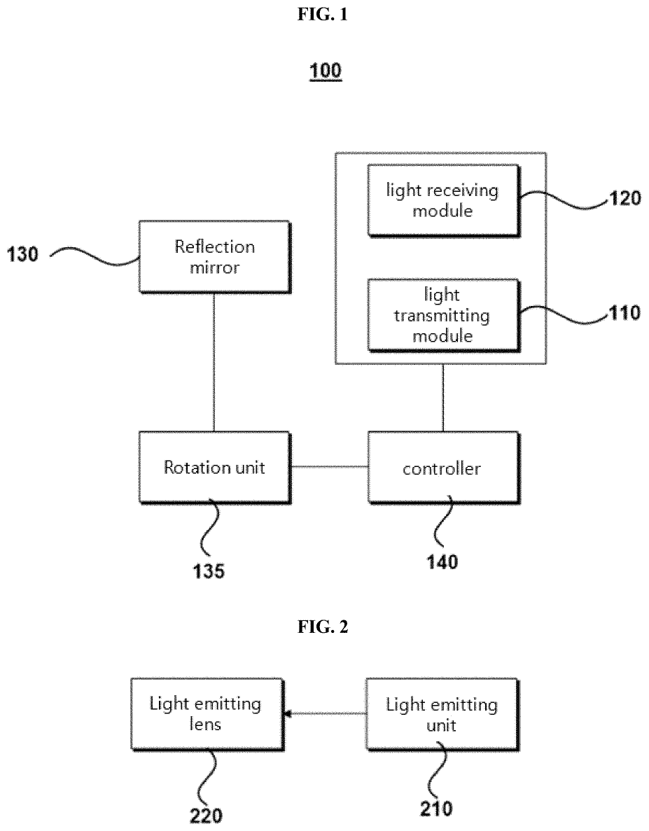

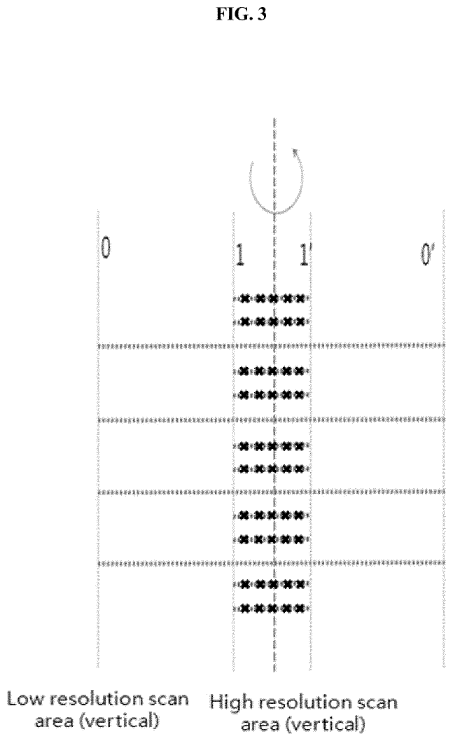

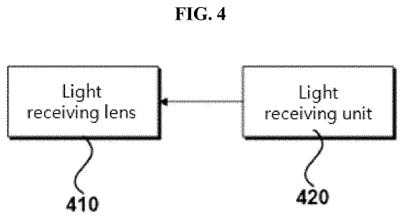

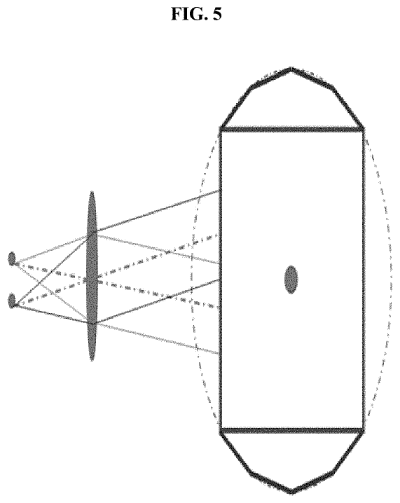

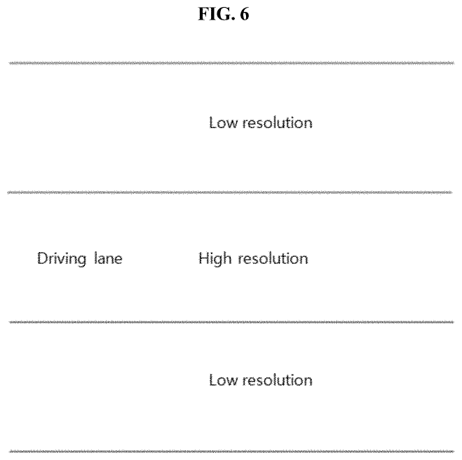

FIG. 1 is a block diagram illustrating schematically a lidar device according to an embodiment of the disclosure, FIG. 2 is a view illustrating schematically light transmitting modules according to an embodiment of the disclosure, and FIG. 3 is a view illustrating method of increasing a vertical resolution according to an embodiment of the disclosure. FIG. 4 is a view illustrating schematically a light receiving module according to an embodiment of the disclosure, FIG. 5 is a view illustrating a shape of a reflection mirror according to an embodiment of the disclosure, and FIG. 6 is a view illustrating method of dividing a scanned area to multiple areas with different resolution and scanning the areas according to an embodiment of the disclosure.

In FIG. 1, a lidar device 100 of the present disclosure includes a light transmitting module 110, a light receiving module 120, a reflection mirror 130, a rotation unit 135 and a controller 140.

The light transmitting module 110 transmits a light. The light transmitting module 110 may emit the light to scan an interested area with high resolution. Here, the light transmitting module 110 may emit multiple lights in different directions to scan simultaneously multiple interested areas as well as one interested area.

The light transmitting module 110 divides the interested area (or a scanned area) into multiple areas and then may control the emitted light to scan a central part with high resolution and scan a surrounding part with low resolution. This will be described below.

In FIG. 2, the light transmitting module 110 of the present disclosure includes a light emitting unit 210 and a light emitting lens 220.

The light emitting unit 210 includes a laser diode LD. High resolution scanning about a desired area may be achieved by adjusting an operation frequency of the LD. Additionally, at least one of the horizontal resolution and the vertical resolution may be adjusted by controlling the operation frequency of the LD. That is, the vertical resolution may increase according as the light passes through multiple surface areas of the reflection mirror with different vertical angles, due to structure of the reflection mirror with asymmetrical polygonal shape. The light emitting unit 210 according to another embodiment may include multiple LDs. Here, operation frequencies of the LDs may differ. For example, a first LD may operate with a first operation frequency, and a second LD may operate with a second operation frequency.

That is, multiple lights may be outputted in different directions by adjusting the operation frequencies of the LDs. As a result, at least one of the vertical resolution or/and the horizontal resolution of the interested area may increase.

If multiple LDs are used, the vertical resolution and a scanned area (angle) may increase in proportional to the number of LDs.

FIG. 3 shows an example of increasing the vertical resolution about a selected area when multiple LDs are used.

A first light may be outputted form a first LD as shown in a dotted line according as the first LD operates with first operation frequency. In this time, the vertical resolution about the selected area may increase by outputting a laser from a second LD as shown in a x-dotted line by adjusting an operation frequency of the second LD.

If multiple LDs are used, the vertical resolution and/or the horizontal resolution may increase by adjusting the operation frequency of the LD.

FIG. 3 is an example. The vertical resolution may increase in response to rotation of the asymmetric polygonal mirror though one LD is used.

The light emitting lens 220 may be disposed in front of the light emitting unit 210 and collimate the light radiated from the light emitting unit 210. That is, the light emitting lens 220 is a means for collimating the light.

The light receiving module 120 receives the light.

FIG. 4 shows schematically constitution of the light receiving module 120 according to one embodiment of the disclosure. In FIG. 4, the light receiving module 120 of the present embodiment includes a light receiving lens 410 and a light receiving unit 420.

The light receiving lens 410 integrates a light delivered through the reflection mirror 130 and delivers the integrated light to the light receiving unit 420. The light receiving lens 410 may be disposed in front of the light receiving unit 420.

The light integrated by the light receiving lens 410 is received by the light receiving unit 420.

A light integrating unit (not illustrated in FIG. 4) for condensing efficiently the light integrated by the light receiving lens 410 may be further formed between the light receiving lens 410 and the light receiving unit 420.

The reflection mirror 130 reflects the light outputted from the light transmitting module 110 or delivers an incident light to the light receiving module 120.

The reflection mirror 130 has a polygonal shape with multiple surfaces, wherein an angle (slope) of each of the surfaces may differ.

As a non-limiting example, a shape of the reflection mirror 130 is shown in FIG. 5. In FIG. 5, the reflection mirror 130 of the present embodiment may have asymmetrical polygonal shape. That is, the angles (slope) of reflection surfaces of the reflection mirror 130 differ, wherein the reflection mirror 130 may have asymmetrical structure, not symmetrical structure.

The scan resolution and the scanned area of the lidar device 100 may increase by rotation of the reflection mirror 130 with asymmetrical polygonal shape. Furthermore, it is possible to scan the interested area with high resolution in case of necessity while scanning a fixed area with high resolution by adjusting a rotation speed of the reflection mirror 130.

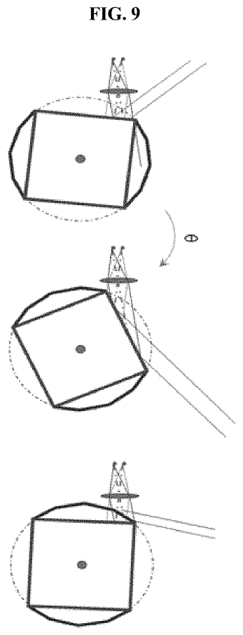

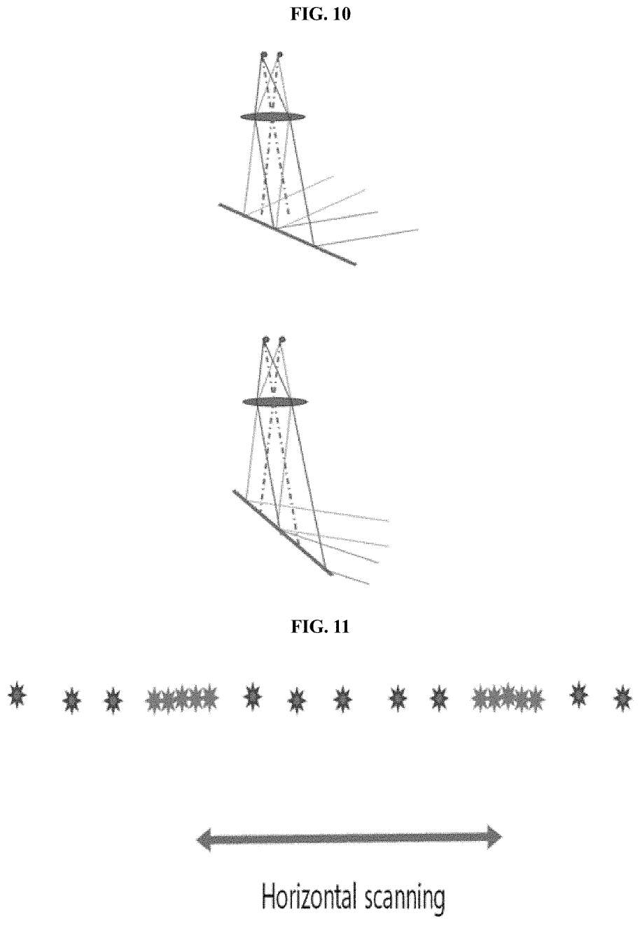

It will be described in detail with reference to drawings FIG. 9 and FIG. 10. As shown in FIG. 9, a reflection angle incident to the reflection surface of the reflection mirror 130 is differently changed in response to the rotation of the reflection mirror 130 because the reflection mirror 130 has the asymmetrical polygonal shape. Moreover, as shown in FIG. 10, the reflection angle of the light differs based on the slope of the reflection surface when the reflection mirror 130 rotates.

High resolution scanning may be realized in an interval where a length of the reflection surface is short though the reflection mirror 130 rotates with the same rotation speed according as the reflection surfaces with considerably short length and different angle are sequentially disposed. Additionally, it is possible to scan a central part with high resolution as shown in FIG. 6 because the reflection mirror 130 has the asymmetrical polygonal shape, and both surrounding parts except the central part may be scanned with low resolution.

In another embodiment, as shown in FIG. 11, it is possible to scan the interested area of the scanned area with a resolution higher than the other area by adjusting the rotation speed of the reflection mirror 130 or the operation frequency of the laser, according as the reflection mirror 130 has the asymmetrical polygonal shape.

A reflection angle of the light reflected by each of the reflection surfaces may be differently adjusted because angles (slopes) of the reflection surfaces of the reflection mirror 130 differ. Accordingly, the reflection surfaces may deliver the light with different reflection angles when the reflection mirror 130 rotates though a light is outputted from the light emitting unit 210, because the reflection mirror 130 has the asymmetrical polygonal shape with different angles of the reflection surfaces.

That is, in the reflection mirror 130, multiple reflection surfaces with a length less than a reference length may be sequentially disposed to scan a partial area with high resolution. As a result, more integrated light may be transmitted to the interested area to scan the interested area with high resolution. In above description, the reflection mirror 130 has the asymmetrical polygonal shape. However, the reflection mirror 130 may not have the asymmetrical polygonal shape. As described below, it is possible to scan a specific interested area with a resolution higher than the other area by adjusting the operation frequency of the laser.

The rotation unit 135 rotates the reflection mirror 130. The rotation unit 135 is combined with the reflection mirror 130 through a bottom of the reflection mirror 130 and may rotate the reflection mirror 130 by 360° in a first direction or a second direction. For example, the rotation unit 135 may be a motor.

The rotation unit 135 may control variably the rotation speed of the reflection mirror 130. Additionally, the rotation unit 135 may control differently a rotation direction and the rotation speed of the reflection mirror 130 depending on a time point.

For example, the rotation unit 135 may rotate the reflection mirror 130 by 360° in a first direction based on a first speed at a first time. Whereas, the rotation unit 135 may rotate the reflection mirror 130 in a second direction based on a second speed at a second time.

This is, the reflection mirror 130 has the asymmetrical polygonal shape with different angle (slope) of reflection surfaces. The light incident to the reflection mirror 130 may be reflected with different angle depending on a reflection surface of the reflection mirror 130 contacted at an incident time, when the rotation unit 135 rotates the reflection mirror 130. As a result, the lidar device 100 may increase the scanned area and scan multiple areas with different resolutions after dividing the scanned area into the multiple areas.

The controller 140 controls elements of the lidar device 100, e.g. the light transmitting module 110, the light receiving module 120, the reflection mirror 130 and the rotation unit 135.

The controller 140 may adjust the operation frequency of the laser to scan a desired scanned area with high resolution or adjust variably the rotation speed of the reflection mirror 130 by controlling the rotation unit 135.

The controller 140 may change the rotation speed of the reflection mirror 130 with different angle of reflection surfaces by controlling the rotation unit 135 to scan the scanned areas with different resolution.

It is assumed that the lidar device 100 is mounted to the vehicle and the scanned area includes a driving lane where the vehicle drives and surrounding lanes when the lidar device 100 scans lanes.

The controller 140 may control to change the rotation speed considering the operation frequency of the LD and the angle of the reflection surface of the reflection mirror 130, to scan a central part corresponding to the driving lane of the scanned area with high resolution and scan a surrounding part corresponding to the surrounding lanes with low resolution.

In another embodiment, the controller 140 may control to adjust the operation frequencies of the LDs to increase the vertical resolution of the scanned area. This is described with reference to the FIG. 3.

In still another embodiment, the controller 140 may control variably the rotation speed considering the angle of the reflection surface of the reflection mirror 130 with the asymmetrical polygonal shape in which the angles of the reflection surfaces differ, to increase the horizontal resolution of the scanned area.

Furthermore, the controller 140 may control the rotation of the reflection mirror 130 with the asymmetrical polygonal shape in which the angles of the reflection surfaces differ to output the light with different reflection angle, thereby increasing at least one of the horizontal resolution and the vertical resolution.

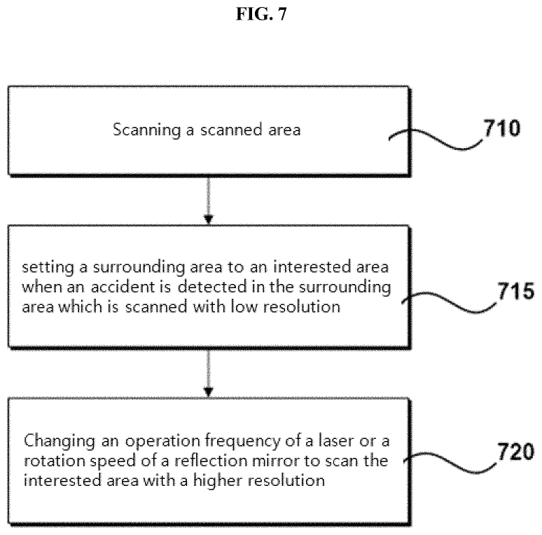

FIG. 7 is a flow chart illustrating an operation method of the lidar device according to an embodiment of the disclosure.

In a step of 710, the lidar device 100 scans an area.

It is assumed that the vehicle to which the lidar device 100 is mounted is driving. The lidar device 100 may scan the central part corresponding to the driving lane with high resolution and scan the surrounding part corresponding to adjacent surrounding lanes with low resolution.

In a step of 715, the lidar device 100 sets a surrounding part in which an accident is detected to an interested area when the accident is detected in the surrounding part scanned with low resolution while it is scanning the scanned area.

In a step of 720, the lidar device 100 changes the operation frequency of the laser or changes the rotation speed of the reflection mirror to scan the interested area with high resolution.

In this time, the lidar device 100 may adjust the operation frequency of the laser or changes the rotation speed of the reflection mirror to scanned areas other than the interested area with low resolution, according as it changes an area scanning with high resolution of the scanned area to the interested area.

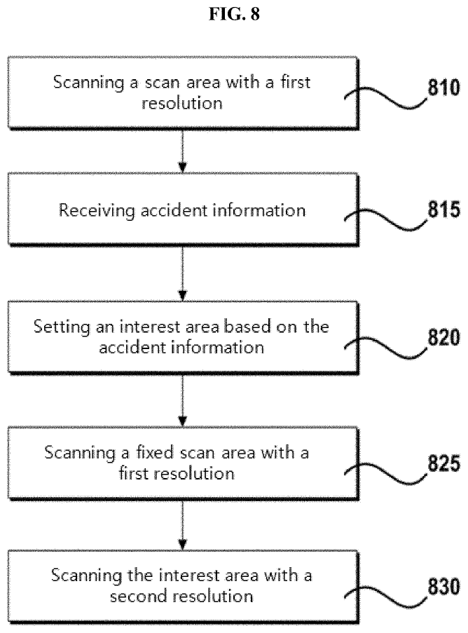

FIG. 8 is a flow chart illustrating an operation method of the lidar device according to another embodiment of the disclosure. In FIG. 8, it is assumed that the lidar device 100 is mounted to the vehicle and the vehicle can perform V2X communication with another vehicle. It is assumed that the vehicle including the lidar device 100 receives road event information including accident information from another vehicle through the V2X communication and the road event information includes information concerning on an accident point.

In a step of 810, the lidar device 100 scans a fixed scanned area with a first resolution.

That is, the lidar device 100 may scan the fixed scanned area in front of the vehicle with the first resolution.

In a step of 815, the lidar device 100 receives accident information. Here, the accident information may include information concerning on an accident point (accident location information).

That is, the lidar device 100 may obtain the accident information through an electronic control unit of the vehicle to which the lidar device 100 is mounted, when the accident information is received from another vehicle.

In a step of 820, the lidar device 100 sets an interested area based on the accident information. For example, the lidar device 100 may set the interested area by using information concerning on the accident point included in the accident information.

In a step of 825, the lidar device 100 scan the fixed scanned area with the first resolution.

In a step of 830, the lidar device 100 scans the set interested area with a second resolution. Here, the second resolution may be different from the first resolution.

The lidar device 100 may scan the interested area by gradually increasing the second resolution according as the vehicle mounted with the lidar device 100 drives to approach the interested area.

For example, in the event that the interested area is far from the lidar device 100, the lidar device 100 may scan the interested area with low resolution. The lidar device 100 increases a resolution about the interested area according as it approaches the interested area due to the driving of the vehicle. The lidar device 100 may adjust the operation frequency of the LD or change the rotation speed of the reflection mirror to scan the interested area with highest resolution, when the interested area exists in a preset range.

The accident information of the disclosure may include information concerning on an object sensed differently from surrounding environment in a scan range as well as the information transmitted from another vehicle through the V2X communication. The resolution may be adjusted based on the accident information. Here, the object may be a vehicle or a person in accident, a walking person or a walking animal, etc.

The technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc.

The hardware mentioned above can be made to operate as one or more software modules that perform the actions of the embodiments of the invention, and vice versa.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. A lidar device comprising:
a light emitting unit configured to emit at least one light;
a reflection mirror configured to reflect the light and have an asymmetrical polygonal shape of which angles of two or more reflection surfaces differ;
a rotation unit configured to rotate the reflection mirror; and
a controller configured to control the rotation unit,
wherein the asymmetrical polygonal shape of the reflection mirror has a structure to scan an interested area of a scanned area with a resolution higher than other area.

2. The lidar device of claim 1, wherein the controller controls the rotation unit to change a rotation speed of the reflection mirror considering the angle of the reflection surface.

3. The lidar device of claim 1, wherein reflection surfaces having a length less than a reference length are sequentially disposed with different angles in the reflection mirror.

4. The lidar device of claim 1, wherein the controller controls a rotation speed of the reflection mirror to scan a selected interested area with high resolution when the interested area is selected by accident information or a user's selection.

5. The lidar device of claim 1, wherein the light emitting unit includes one or more lasers such as a laser diode LD,
and wherein an operation frequency of a laser is adjusted to scan multiple areas with different resolutions.

6. The lidar device of claim 1, wherein the light emitting unit includes multiple lasers disposed to make directions of lights emitted from the lasers differ.

7. The lidar device of claim 1, wherein operation frequencies of lasers can be differently controlled in case that the light emitting unit includes multiple lasers.

8. The lidar device of claim 1, wherein the controller controls a rotation speed of the reflection mirror or adjusts an operation frequency of the light emitting unit by controlling the rotation unit to scan a central part and a surrounding part adjacent to the central part of a scanned area with different resolutions.

9. The lidar device of claim 4, wherein the controller controls the rotation speed of the reflection mirror and an operation frequency of a laser in the light emitting unit to increase gradually a resolution of the interested area according as a vehicle mounted with the lidar device drives to approach the interested area.

10. A lidar device comprising:
a light emitting unit configured to radiate at least one light, the light emitting unit including a laser;
a reflection mirror configured to reflect the light;
a rotation unit configured to rotate the reflection mirror; and
a controller configured to control the rotation unit,
wherein the controller adjusts an operation frequency of the laser to scan an interested area of a scanned area with a resolution higher than other area.

11. The lidar device of claim 10, wherein the light emitting unit includes multiple lasers,
and wherein the controller adjusts the operation frequency for one of the lasers to scan the interested area with high resolution, and
adjusts the operation frequency for another of the lasers to scan the other area with a resolution lower than the resolution of the interested area.

12. The lidar device of claim 10, wherein the controller adjusts a rotation speed of the reflection mirror to scan the interested area of the scanned area with a resolution higher than a resolution of the other area.

13. The lidar device of claim 10, wherein the operation frequency of the laser is adjusted to scan a selected interested area with a higher resolution when the interested area is selected by accident information or a user's selection.

14. A method of operating a lidar device in a vehicle, the method comprising:
(a) scanning a scanned area;
(b) selecting an interested area by using a scan result of the scanned area; and
(c) rotating a reflection mirror with an asymmetrical polygonal shape to scan the interested area with a resolution higher than a resolution of other area.

15. The method of claim 14, wherein in the step of (c), the rotation speed of the reflection mirror is adjusted to increase gradually a resolution concerning on the interested area according as the lidar device approaches the interested area due to driving of the vehicle.

16. A method of operating a lidar device in a vehicle, the method comprising:
(a) selecting an interested area by using accident information when the accident information is received from other vehicle; and
(b) adjusting an operation frequency of a laser and a rotation speed of a reflection mirror to scan a fixed scanned area and the interested area with different resolutions.

17. The method of claim 16, wherein the fixed scanned area includes multiple adjacent areas,
and wherein the step of (b) includes:
scanning a first area of the areas with a first resolution by operating one of the lasers with a first operation frequency; and
scanning a second area with a second resolution by operating another laser with a second operation frequency.

18. The method of claim 16, wherein in the step of (b), the operation frequency of the laser is differently adjusted depending on a distance to the interested area,
and wherein the operation frequency is adjusted to increase gradually a resolution concerning on the interested area according as the lidar device approaches the interested area.
